(19) United States
(12) Patent Application Publication
(10) Pub. No.: US 2015/0033529 A1
(43) Pub. Date: Feb. 5, 2015

(54) DEVICE AND METHOD FOR MAINTENANCE OF A GRINDING MILL

(71) Applicant: Metso Minerals Industries, Inc., Waukesha, WI (US)

(72) Inventor: Jonathan Charles Allen, York, PA (US)

(73) Assignee: Metso Minerals Industries, Inc., Waukesha, WI (US)

(21) Appl. No.: 13/955,217

(22) Filed: Jul. 31, 2013

(51) Int. Cl. B02C 23/00

(52) U.S. Cl. CPC B02C 23/00
USPC 29/402.01; 241/301; 241/101.2

(57) ABSTRACT

A device and method for maintenance of a grinding mill. The device includes a movable maintenance tool for maintenance inside said grinding mill, and at least one attachment element adapted to be connected to a fixed point (P) in relation to said grinding mill for attaching said device to said fixed point (P).

### FIELD OF THE DISCLOSURE

The present disclosure relates to a device and a method for maintenance of a grinding mill.

### BACKGROUND

Grinding mills are normally used to grind mine ore or primary crusher product. One type of grinding mills comprises a drum, in which the material to be ground, i.e. the charge, is ground by rotating the drum. The charge is ground by the action of impacts of the charge on the inside wall surface of the drum, as well as impacts of portions of the charge with each other. In some types of horizontal drum mills, called a Ball mills or SAG mills, balls of hard material, are introduced in the drum, with the charge. When the drum is rotated, the charge is ground also by the action of impacts from the balls.

Another type of grinding mill comprises a container in which an agitator is arranged. Grinding media, such as steel balls or ceramic or natural pebbles, is provided in the container. Water and the material to be ground are fed into the container. By rotating the agitator, the charge is agitated, such that the grinding media grinds the material to be ground by abrasion and attrition. This type of grinding mill may be orientated either vertically or horizontally.

The inside parts of these types of grinding mills are heavily exposed to wear during the grinding process. Therefore, the inside parts of a grinding mill is normally covered with some kind of wear protection, such as wear-resistant liner elements. These liner elements are large, heavy and difficult to handle in a. safe and reliable way. Different types of tools and lifting devices have been provided in order to be able to handle the liner elements in a way that is safe for the maintenance personnel. There are, however, problems associated with the tools and lifting devices existing on the market today. The devices must be able to handle considerable forces when the liner elements are to be replaced and are therefore heavy and clumsy.

### SUMMARY

It is an objective of the present invention to provide an improvement of the above technique and prior art. More particularly, it is an objective of this invention to provide an improved device maintenance of a grinding mill which is simple and easy to handle in order to perform safe and reliable maintenance operations Within the grinding Mill.

According to a first aspect, these and other objects, and/or advantages that will be apparent from the following description of embodiments, are achieved, in full or at least in part, by a device for maintenance of a grinding mill, comprising a movable Maintenance tool for maintenance inside the grinding mill, and at least one attachment element adapted to be connected to a fixed point in relation to said grinding mill for attaching the device to the fixed point. By attaching the device directly to a fixed point in relation to the grinding mill the forces exerted on the device during use will in turn be transferred to the fixed point. The need for a heavy and stable device capable of handling the forces in itself is therefore heavily decreased.

The fixed point may be located on an outer surface of the grinding mill which is advantageous in that all of the forces exerted on the maintenance tool will go into the grinding mill.

The fixed point may be located on a surface of a mobile object which is advantageous in that all of the forces exerted on the maintenance tool will 20 directly into the mobile object.

The fixed point may be located on a surface of a stationary object which is advantageous in that all of the forces exerted on the maintenance tool will go directly into the stationary object.

The device may be attachable to the fixed point during operation of the grinding mill. This is advantageous in that the time period for performing the maintenance operation of the grinding mill can be kept to a minimum.

The maintenance tool may comprise a tool portion for maintenance inside said grinding mill which is one preferred embodiment of the present invention.

The maintenance tool may comprise an arm, an inner end of the arm being connected to the attachment element, and the tool portion being arranged at an outer end of the arm. The attachment element will transfer the forces exerted on the tool portion arranged at an outer end of the arm directly to the fixed point.

The tool portion may comprise a tool holder adapted to be connected to an interchangeable tool part. A problem with conventional maintenance tools and devices is that they are only capable of performing. one single maintenance operation. Thus, a number of different tools or devices are needed in order to be able to perform all of the necessary maintenance operations within the grinding mill. The interchangeable tool part of the present invention will eliminate that problem. The interchangeable tool part may for example be chosen from a group consisting of a ball charge removal tool and a liner element handling tool.

The arm may comprise at least four rotary joints, such that said tool portion is maneuverable inside said grinding mill, The maintenance tool may further be movable in a translational movement in a direction generally parallel to a central axis of the grinding mill. This is advantageous in that the arm will be extremely movable and able to reach every portion of the inside of the grinding mill.

In one preferred embodiment of the invention the arm may comprise five rotary joints and three of the rotary joints are provided in the tool holder.

The grinding mill may be a vertical grinding mill which is a grinding mill specifically suitable for the maintenance device of the present invention.

According to a second aspect of the invention, the invention relates to a minding. mill comprising a maintenance device according to the above described features.

According to a third aspect of the invention, the invention relates to a method for maintenance of a grinding mill using a maintenance device, the maintenance device comprising a movable maintenance tool for maintenance inside the grinding mill. The method comprises the steps of attaching the maintenance device to a fixed point in relation to the grinding mill, introducing a tool portion of the maintenance tool inside the grinding mill, and performing a maintenance operation by means of the tool portion.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

As used herein, the term “comprising” and variations of that term are not intended to exclude other additives, components, integers or steps.

The method disclosed herein is not limited to the device also disclosed herein. Any suitable device may be used in order to implement the method for maintenance of a grinding mill.

Various other features, objects and advantages of the invention will be made apparent from the following description taken together with the drawings.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals will be used for similar elements, and wherein:

FIG. 1 is a perspective view of a device for maintenance of a grinding mill according to one exemplary embodiment of the invention;

FIG. 2 is a perspective view of the device in FIG. 1 when attached to the grinding mill and equipped with a ball charge removal tool; and

FIG. 3 is a perspective view of the device in FIG. 1 when attached to the grinding mill and equipped with a liner element handling tool.

### DETAILED DESCRIPTION

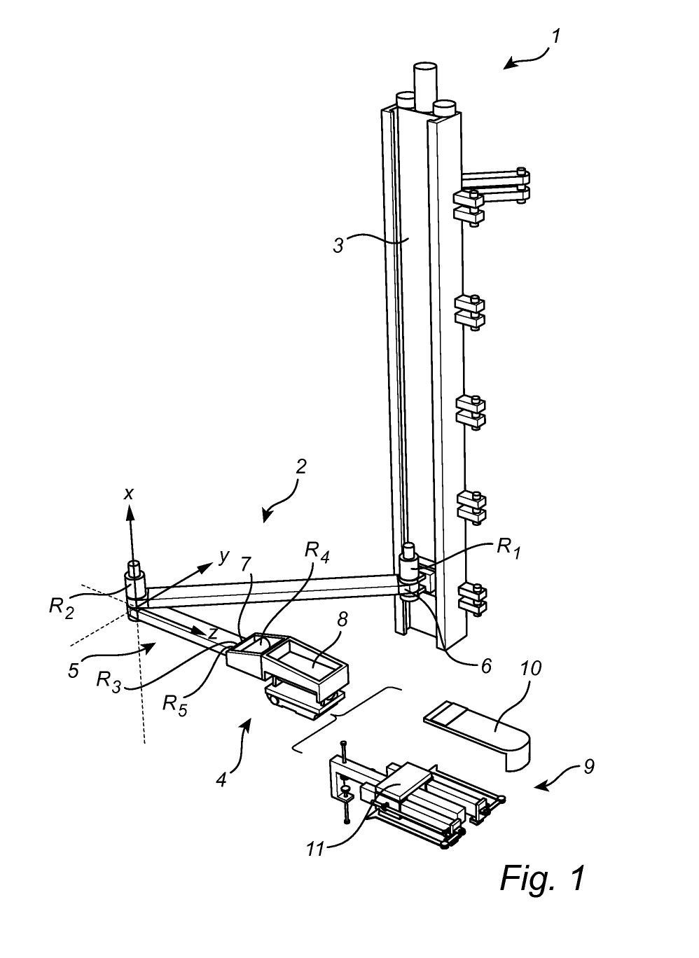

FIG. 1 illustrates a device 1 for maintenance of a grinding mill 12 according to one exemplary embodiment of the invention. The device 1 comprises a movable maintenance tool 2 for maintenance inside the grinding mill 12, and an attachment element 3 which is adapted to be connected to a fixed point P in relation to the grinding mill 12 for attaching the device 1 to the fixed point P. The device 1 is designed such that it is attachable to the fixed point P during operation of the grinding mill 12. The maintenance tool 2 comprises a tool portion 4 for maintenance inside the grinding mill 12. The maintenance tool 2 further comprises an arm 5. The arm 5 has an inner end 6 which is connected to the attachment element 3, and an outer end 7 at which the tool portion 4 is arranged. The tool portion 4 comprises a tool holder 8 which is adapted to be connected to an interchangeable tool part 9. The interchangeable tool part 9 can be of any sort suitable for performing a maintenance operation, such as, for example. a ball charge removal tool 10 or a liner element handling tool 11. The arm 5 has five rotary points R₁-R₅ in order to be able to reach every portion of the inside of the grinding mill 12. Three of the rotary points R₃-R₅ are provided in the tool holder 8 which makes it movable in virtually any direction. The rotary points R₁ and R₂ make the arm 5 movable around the x-axis, the rotary point R₃ makes the tool holder movable around the x-axis, the rotary point R₄ makes the tool holder movable, around the y-axis, and the rotary point R₅ makes the tool holder movable around the z-axis.

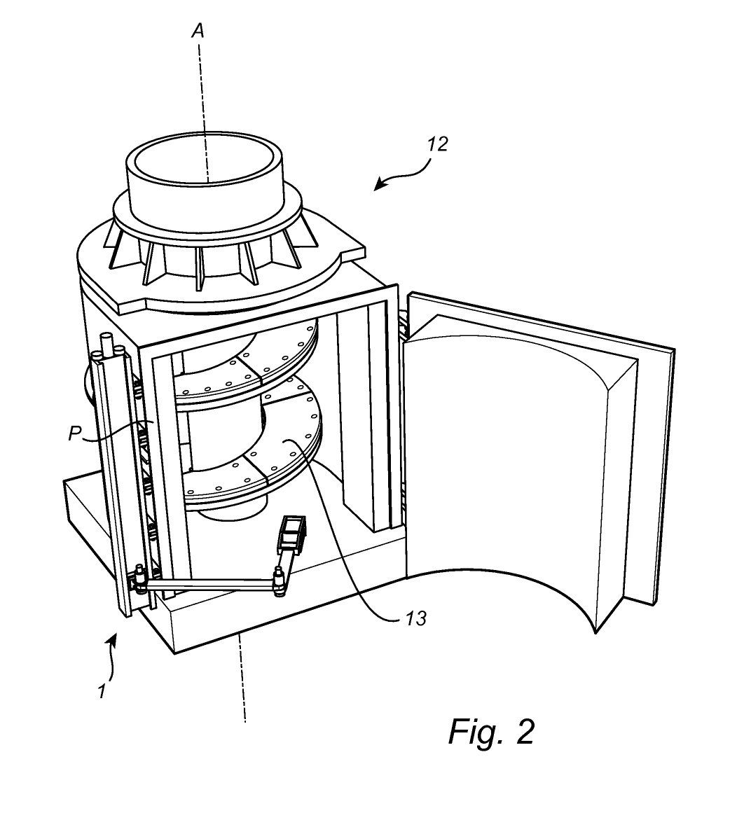

In FIG. 2, the device 1 is illustrated when attached to the grinding mill 12 and equipped with the ball charge removal tool 10. In this preferred embodiment, the fixed point. P is located on the grinding mill 12 which is a vertical grinding mill 12. The maintenance tool 2 is movable in a translational movement in a direction generally parallel to a central axis A of the grinding mill 12.

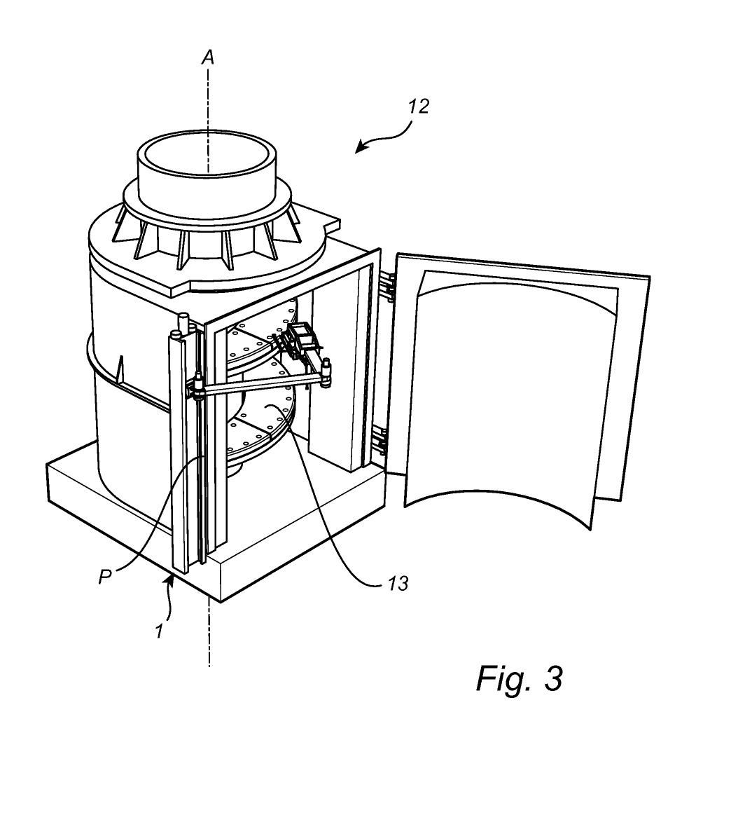

FIG. 3 illustrates the device 1 when attached to the grinding mill 12 and equipped with the liner element handling tool 11. The maintenance tool 2 has been moved vertically in the longitudinal direction of the attachment element 3 in order to align with a liner element 13 for maintenance.

When a maintenance operation is to he performed within the grinding mill 12, such as, for example, the replacement of a liner element in the grinding mill 12, the device 1 is attached to the fixed point P in relation to the grinding mill 12 by means of the attachment element 3. The attachment of the device 1 to the grinding mill 12 can be performed during operation of the grinding mill 12. Thereafter, the operation of the grinding mill 12 is stopped and the tool portion 4 of the maintenance tool 2 is introduced inside the grinding mill 12 such that a maintenance operation can be performed by means of the tool portion 4. The interchangeable tool part 9 is chosen depending on the maintenance operation to be performed. When a liner element 13 is to be replaced, the liner element handling tool 11 is connected to the tool holder 8 of the tool portion 4. The liner element handling tool 11 is thereafter aligned with the liner element 13 to be replaced by means of the arm S of the maintenance tool 2 so that it can be connected to the liner element 13. When the liner element handling tool 11 has been connected with the liner element 13 it is removed from the grinding mill 12 and replaced with a new or reconditioned liner element 13. When the maintenance operation of the grinding mill 12 is completed the grinding operation of the grinding mill 12 can be restarted while the device 1 is being detached from the grinding mill 12.

Other examples of maintenance operations for which the tool could be used is for opening the door to the grinding chamber of the grinding mill and for activating the ball charge removal valve.

The skilled person realizes that a number of modifications of the embodiments described herein are possible without departing from the scope of the invention, which is defined in the appended claims.

For instance, the fixed point to which the device is attached may be located on an outer surface of a mobile object, such as a vehicle of some sort.

The number of rotary joints provided on the arm may be varied in different embodiments. In a preferred embodiment, however, the arm comprises at least four rotary joint such that the tool portion will be maneuverable in any direction within the grinding mill.

This written description uses examples to disclose the invention including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A device for maintenance of a grinding mill, comprising,
a movable maintenance tool for maintenance inside said grinding mill, and
at least one attachment element adapted to be connected to a fixed point in relation to said grinding mill for attaching said device to said fixed point.

2. The device according to claim 1, wherein said fixed point is located on an outer surface of said grinding mill.

3. The device according to claim 1, wherein said fixed point is located on a surface of a mobile object.

4. The device according to claim 1, wherein said device is attachable to said fixed point during operation of said grinding mill.

5. The device according to claim 1, wherein said maintenance tool comprises a tool portion for maintenance inside. said grinding

6. The device according to claim 5, wherein said maintenance tool comprises an arm, an inner end of said arm being, connected to said attachment element, and said tool portion being, arranged at an outer end of said arm.

7. The device according to claim 5, wherein said tool portion comprises a tool holder adapted to be connected to an interchangeable tool part.

8. The device according to claim 7, wherein said interchangeable tool part is chosen from a group consisting of a ball charge removal tool and a liner element handling tool.

9. The device according to any one of claim 6, wherein said arm comprises at least four rotary joints (R₁-R₄), such that said tool portion is maneuverable inside said grinding mill.

10. The device according to claim 9, wherein said arm comprises five rotary joints (R₁-R₅).

11. The device according to claim 9, wherein said tool portion comprises a tool holder adapted to be converted to an interchangeable tool part, wherein three of said rotary joints are provided in said tool holder.

12. The device according to claim 1, wherein said maintenance tool is movable in a translational movement in a direction generally parallel to a central axis of said grinding mill.

13. The device according to claim 1, wherein said grinding mill is a vertical minding mill.

14. A grinding mill comprising a maintenance device according to claim 1.

15. A method for maintenance of a grinding mill using a maintenance device, said maintenance device comprising a. movable maintenance tool for maintenance inside said grinding mill, said method comprising the steps of:
attaching said maintenance device to a fixed point in relation to said grinding mill,
introducing a tool portion of said maintenance tool inside said grinding mill, and
performing a maintenance operation by means of said tool portion.

16. The method according to claim 15, wherein the step of attaching said maintenance device to said fixed point is performed during operation of said grinding mill.
